(19) United States
(12) Patent Application Publication
(10) Pub. No.: US 2026/0214764 A1
(43) Pub. Date: Jul. 23, 2026

(54) DRIVING CIRCUIT AND DEVICE FOR VEHICLE LED INDICATOR LIGHT

(71) Applicant: Shenzhen Shenhang Huachuang Automobile Technology Co., Ltd., Shenzhen (CN)

(72) Inventor: Guanfu Huang, Qiannan Buyi and Miao Autonomous Pre (CN)

(21) Appl. No.: 19/571,100

(22) Filed: Mar. 18, 2026

(51) Int. Cl. H05B 45/30; B60Q 1/30; B60Q 1/44; B60Q 1/50; B60R 1/04; B60R 1/06; B60R 1/12

(52) U.S. Cl. CPC H05B 45/30; B60Q 1/30; B60Q 1/44; B60Q 1/543; B60R 1/1207; B60Q 2400/20; B60R 1/04; B60R 1/06

(57) ABSTRACT

Provided are a driving circuit and a device for vehicle LED indicator light, the driving circuit includes a main control module, a CAN decoding module, an interface module, a power supply module, and an LED light driving module. The power supply module includes independent first voltage reduction module, second voltage reduction module, and third voltage reduction module that are all connected to the interface module to obtain a power supply voltage of a vehicle power supply. The first voltage reduction module is connected to the CAN decoding module to convert the power supply voltage into a first working voltage; the second voltage reduction module is connected to the main control module to convert the power supply voltage into a second working voltage; the third voltage reduction module is connected to the LED indicator light to convert the power supply voltage into a third working voltage.

### TECHNICAL FIELD

The present disclosure relates to the field of vehicle indicator light driver technologies, and in particular, to driving circuits and device for vehicle light-emitting diode, (LED) indicator light.

### BACKGROUND

With the intelligent and personalized development of vehicle interiors, vehicle ambient lights/indicator lights have become mainstream in vehicle auxiliary electronic devices. The power supply system, as the core component in vehicle light control circuit, directly determines the stability of the main control module and light drive module through its voltage regulation topology design, power supply isolation, and ripple suppression ability, thereby affecting the control accuracy and reliability of the entire circuit.

In the current power supply design of vehicle light control circuits, the voltage regulation branch is designed to be single. The commonly used cascaded buck architecture for LED lights in the control circuit is a 12V power supply for vehicles, ranging from 5V to 3.3V Microcontroller Unit, (MCU), power supply for different functional modules such as communication modules, that is, different functional modules share the same low-voltage power supply link, and there is a lack of effective hardware power isolation between each functional module. This results in current noise and electromagnetic interference generated by power devices such as LED lights being transmitted to the MCU and communication module through the shared power supply link, causing serious power crosstalk. At the same time, the ripple and voltage fluctuations of the front 5V branch will be directly transmitted to a rear 3.3V branch, and combined with the ripple interference of the vehicle's 12V power supply itself, it will also reduce the power supply accuracy of the rear 3.3V, increase the ripple of the rear 3.3V, and cannot meet the stable operation requirements of MCUs that require 3.3V power supply.

### SUMMARY

The present application provides a driving circuit and a device for vehicle LED indicator light, which enables effective hardware power isolation between a main control module, a CAN decoding module, and a LED indicator light, effectively preventing the LED indicator light from affecting other modules through the power supply link, and also avoiding the problem of a front-end power supply branch affecting a back-end power supply voltage, improving the stability of circuit operation.

The present application provides a driving circuit for vehicle LED indicator light, including: a main control module, a CAN decoding module, an interface module, a power supply module, and an LED light driving module;
the interface module is connected to a vehicle power supply, and the power supply module is connected to the interface module, the main control module, the CAN decoding module, and the LED driving module to provide power supply; the CAN decoding module is connected to a vehicle CAN bus through the interface module and is configured to receive a vehicle state signal transmitted on the vehicle CAN bus; the main control module is connected to the CAN decoding module and is configured to generate a LED driving signal based on the vehicle state signal and transmit it to the LED light driving module; the LED light driving module is connected to the LED indicator light through the interface module and is configured to control the LED indicator light to turn on according to the LED driving signal;
the power supply module includes independent first voltage reduction module, second voltage reduction module, and third voltage reduction module; the first voltage reduction module, second voltage reduction module, and third voltage reduction module are all connected to the interface module to obtain a power supply voltage of the vehicle power supply; the first voltage reduction module is connected to the CAN decoding module to convert the power supply voltage into a first working voltage of the CAN decoding module; the second voltage reduction module is connected to the main control module to convert the power supply voltage into a second working voltage of the main control module; the third voltage reduction module is connected to the LED indicator light to convert the power supply voltage into a third working voltage of the LED indicator light.

The present application further provides a vehicle LED indicator light device, including an LED indicator light and the driving circuit described above;
the LED indicator light includes two outer side rearview mirror indicator lights, two inner side rearview mirror indicator lights, and a rear tail light; the two outer side rearview mirror indicator lights are respectively provided on outer sides of housing of a left rearview mirror and a right rearview mirror of the vehicle, the two inner side rearview mirror indicator lights are respectively provided on inner sides of housing of the left rearview mirror and the right rearview mirror of the vehicle; the rear tail light is provided outside of a rear of the vehicle; the driving circuit is connected to the outer side rearview mirror indicator lights, the inner side rearview mirror indicator lights, and the rear tail light, and is configured to drive an outer side rearview mirror indicator light on the same side as a door to light up when receiving an opening command of the door, drive the rearview mirror indicator light on the same side as an incoming vehicle when receiving a warning signal from the side, drive the rear tail light to light up in a first color when receiving an intelligent driving mode activation command, drive the rear tail light to light up in a second color when receiving a braking command, and drive the rear tail light to light up in a third color when receiving a navigation mode selection command.

Beneficial technical effect: the power supply module of the present application includes the first voltage reduction module, the second voltage reduction module, and the third voltage reduction module that are independent of each other. The three voltage reduction modules are used to supply power to the CAN decoding module, the main control module, and the LED indicator light, respectively. Therefore, different modules use different power supply links for power supply, achieving effective hardware power supply isolation between the main control module, the CAN decoding module, and the LED indicator light, effectively preventing the LED indicator light from affecting other modules through the power supply link, and avoiding the problem of the previous power supply branch affecting the subsequent power supply voltage, thus improving the stability of circuit operation.

### BRIEF DESCRIPTION OF DRAWINGS

FIG. 1 is a schematic structural diagram of a driving circuit for vehicle LED indicator light in an embodiment of the present application.

FIG. 2 is a circuit schematic diagram of a first voltage reduction module in an embodiment of the present application.

FIG. 3 is a circuit schematic diagram of a second voltage reduction module in an embodiment of the present application.

FIG. 4 is a first circuit schematic diagram of a third voltage reduction module in an embodiment of the present application.

FIG. 5 is a circuit schematic diagram of an interface module in an embodiment of the present application.

FIG. 6 is a circuit schematic diagram of a main control module in an embodiment of the present application.

FIG. 7 is a circuit schematic diagram of a CAN decoding module in an embodiment of the present application.

FIG. 8 is a circuit schematic diagram of a wireless communication module in an embodiment of the present application.

FIG. 9 is a circuit schematic diagram of an LED driving module of the present application.

FIG. 10 is a second circuit schematic of another third voltage reduction module of the present application.

### DESCRIPTION OF EMBODIMENTS

Please refer to the figures, where the same component symbols represent the same components. The principle of the present disclosure is illustrated by implementing it in an appropriate computing environment. The following explanation is based on the specific embodiments of the present disclosure, and should not be construed as limiting other specific embodiments of the present disclosure that are not described in detail herein.

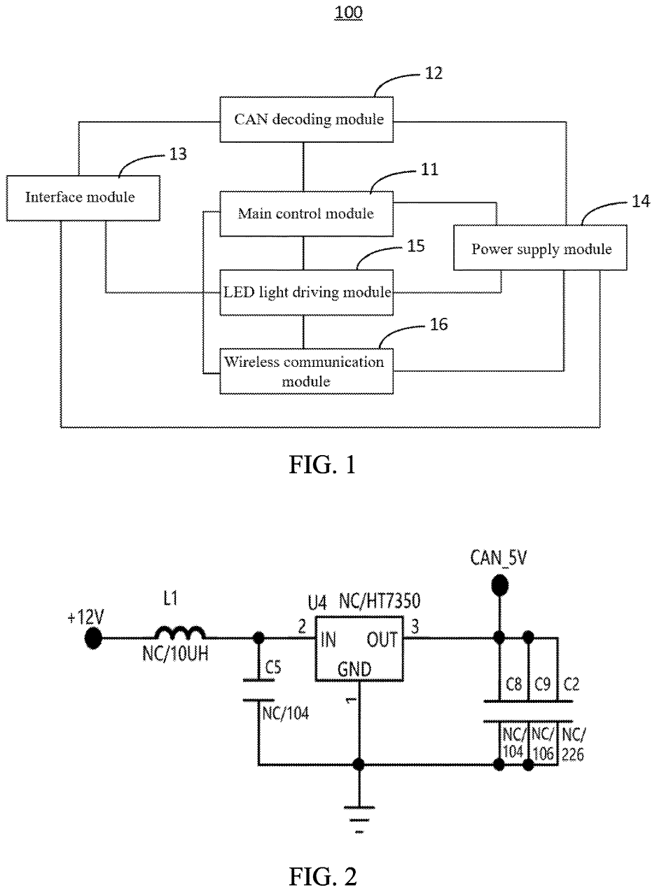

Referring to FIG. 1, an embodiment of the present disclosure discloses a driving circuit 100 for vehicle LED indicator light, which can be integrated and installed on a vehicle control board. It includes a main control module 11, a Controller Area Network, (CAN) decoding module 12, an interface module 13, a power supply module 14, and an LED light driving module 15.

The interface module 13 serves as a connection hub between the driving circuit 100 and an external device in the vehicle, and is connected to a vehicle power supply. In this embodiment, the vehicle power supply is preferably a conventional 12V Direct Current, (DC) power supply, which is compatible with the power supply standards of most passenger vehicle models. The power supply module 14 is respectively connected to the interface module 13, the main control module 11, the CAN decoding module 12, and the LED driving module, serving as a power supply core of the entire driving circuit 100, thereby providing stable and adaptable working voltage for each functional module. The CAN decoding module 12 is connected to a vehicle CAN bus through the interface module 13, and is configured to receive a vehicle state signal transmitted on a vehicle CAN bus (such as door opening, oncoming traffic, driving mode switching, etc.), complete the decoding and conversion of the CAN bus signal. The main control module 11 is connected to the CAN decoding module 12, and is configured to receive a decoded vehicle state signal, generate a LED driving signal based on the decoded vehicle state signal, and transmit it to the LED light driving module 15. The LED light driving module 15 is connected to the LED indicator light through the interface module 13, and is configured to control the brightness, color, flashing state, etc. of the LED indicator light based on the LED driving signal.

Where, the power supply module 14 includes independent first voltage reduction module, second voltage reduction module, and third voltage reduction module. The first voltage reduction module, second voltage reduction module, and third voltage reduction module are all connected to the interface module 13 to obtain a power supply voltage of the vehicle power supply. The first voltage reduction module is connected to the CAN decoding module 12 to convert the power supply voltage into a first working voltage of the CAN decoding module 12. The second voltage reduction module is connected to the main control module 11 to convert the power supply voltage into a second working voltage of the main control module 11. The third voltage reduction module is connected to the LED indicator light to convert the power supply voltage into a third working voltage of the LED indicator light. Therefore, by using three independent voltage reduction modules to supply power to different modules, that is, different modules use different power supply links for power supply, effective hardware power isolation is achieved between the main control module 11, CAN decoding module 12, and LED indicator light, effectively preventing the LED indicator light from affecting other modules through the power supply link, and avoiding the problem of the previous power supply branch affecting a subsequent power supply voltage, thus improving the stability of circuit operation.

In an implementation mode, as shown in FIG. 2, the first voltage reduction module includes an inductor L1, a capacitor C5, a voltage regulator chip U4, a capacitor C8, a capacitor C9, and a capacitor C2.

One end of the inductor L1 is connected to the power supply voltage of the vehicle power supply, playing a role in front-end current limiting and surge prevention. The other end of the inductor L1 and one end of the capacitor C5 are both connected to a 2^{nd} pin of the voltage regulator chip U4, forming the voltage input electrode of the voltage regulator chip. The other end of the capacitor C5 and a 1^{st} pin of the voltage regulator chip U4 are both grounded, completing the filtering and grounding processing of the input circuit. A 3^{rd} pin of the voltage regulator chip U4 is a voltage output pin, which outputs the first working voltage CAN_5V to power the CAN decoding module 12. One end of the capacitor C8, one end of the capacitor C2, and one end of the capacitor C9 are all connected to the 3^{rd} pin of the voltage regulator chip U4, and the other ends are grounded, forming a multi-stage output filtering circuit to filter out impurities and ripples in the output voltage and reduce power supply interference of the CAN decoding module 12.

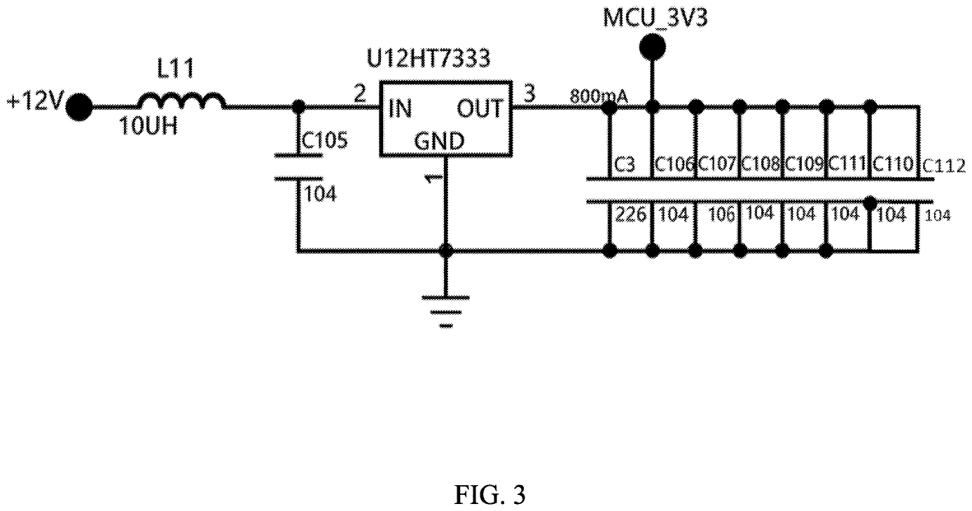

As shown in FIG. 3, the second voltage reduction module includes an inductor L1, a capacitor C105, a voltage regulator chip U12, a capacitor C3, a capacitor C106, a capacitor C107, a capacitor C108, a capacitor C109, a capacitor C110, and a capacitor C111. The specific connection relationships of each component can refer to the circuit schematic shown in FIG. 3, and will not be repeated here. One end of the inductor L11 is connected to the power supply voltage of the vehicle power supply, which can achieve front-end current limiting protection. A 3^{rd} pin of the voltage regulator chip U12 outputs the second working voltage MCU_3V3. The capacitor C3, capacitor C106, capacitor C107, capacitor C108, capacitor C109, capacitor C110, and capacitor C111 form a high-density output filtering network to filter out voltage ripple and ensure the accuracy and no lag of an operation of the main control module 11.

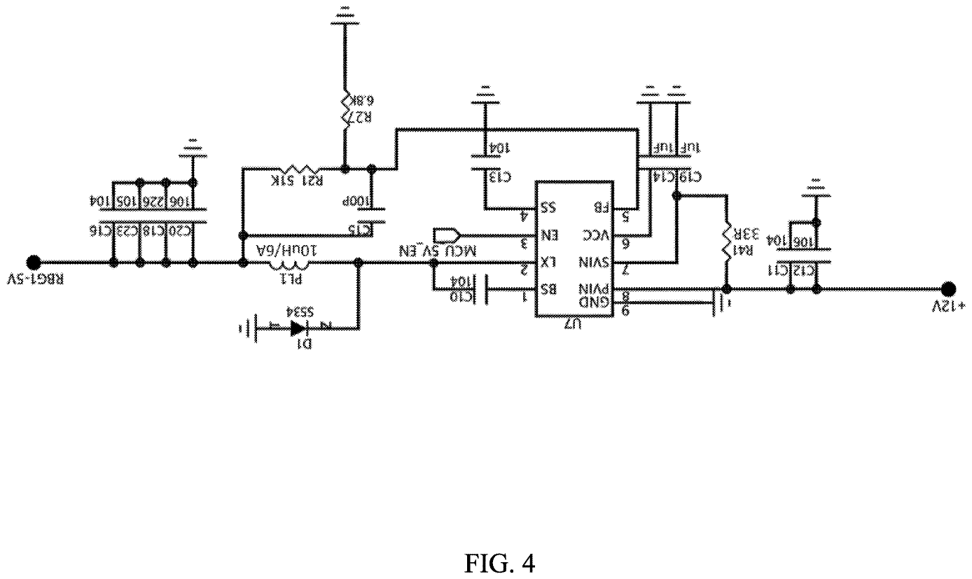

As shown in FIG. 4, the third voltage reduction module is a dedicated power supply circuit for the LED indicator light, which converts the vehicle's 12V voltage into the third working voltage RGB1_5V adapted to the LED beads. It adopts a power management chip control mode and supports enable signal regulation. It includes a power management chip U7, an inductor PL1, a diode D1, a resistor R41, a resistor R21, a resistor R27, a capacitor C10, a capacitor C11, a capacitor C12, a capacitor C13, a capacitor C14, a capacitor C15, a capacitor C16, a capacitor C18, a capacitor C19, a capacitor C20, and a capacitor C23.

The power supply of the vehicle power supply is filtered in parallel by capacitors C11 and C12 to remove input voltage noise, and connected to an 8^{th} pin of the chip U7. The resistor R41 is connected between a 7^{th} pin and the 8^{th} pin of the chip U7, providing voltage division and chip startup protection. A 6^{th} pin and the 7^{th} pin of the chip U7 are grounded through capacitors C14 and C19 respectively, which can achieve internal circuit filtering of the chip. The capacitor C10 is connected between a 1st pin and a 2^{nd} pin of the chip U7, and the 2^{nd} pin of the chip U7 is connected to an output node through the inductor PL1 to output the third operating voltage RGB1_5V through the output node. A negative electrode of the diode D1 is connected to the 2^{nd} pin of the chip U7, and a positive electrode is grounded, serving as a freewheeling and reverse cutoff protection to prevent reverse breakdown of the circuit. The capacitors C16, C18, C20, and C23 form an output filtering circuit, with one end connected to the output node and the other end being grounded. A resistor R21 and a capacitor C15 are connected in parallel between a 5^{th} pin of the chip U7 and the output node. One end of the resistor R27 is connected to the 5^{th} pin of the chip U7, and the other end is grounded, forming a voltage feedback loop to achieve precise control of the output voltage. A 3^{rd} pin of the chip U7 is connected to an enable signal MCU_5V EN output by the main control module 11. The enable signal MCU_5V EN is configured to control the start and stop of the third voltage reduction module, achieving on-demand power supply for the LED indicator light. A 4^{th} pin of the chip U7 is grounded through the capacitor C13 to complete the chip reference voltage filtering.

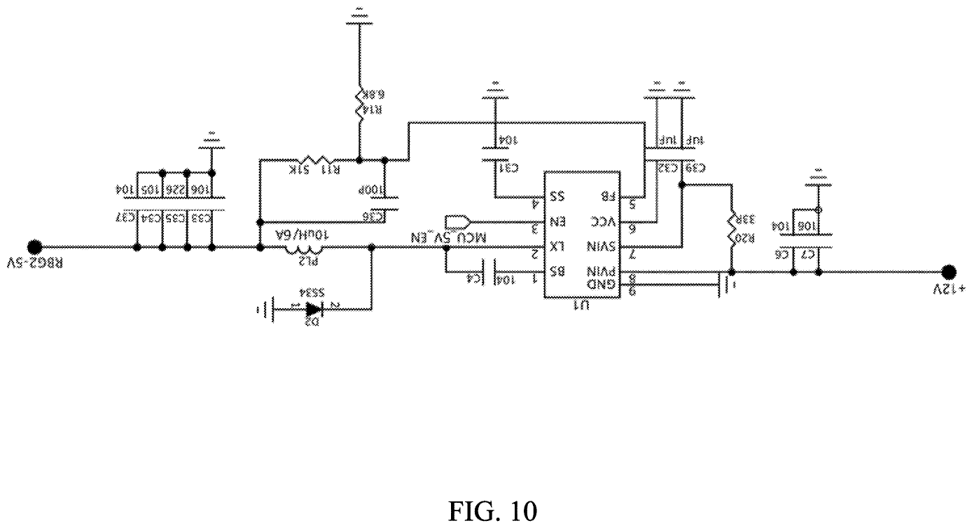

In order to meet the independent power supply requirements of two sets of RGB three color light sources, the third voltage reduction module in this embodiment is arranged to two sets, and the circuit principle of the other set of third voltage reduction modules is shown in FIG. 10. As shown in FIG. 10, the third voltage reduction module outputs the third working voltage RGB2_5V. The two sets of modules have the same structure and work independently to supply power to the two sets of RGB light sources, further avoiding power interference between the light groups.

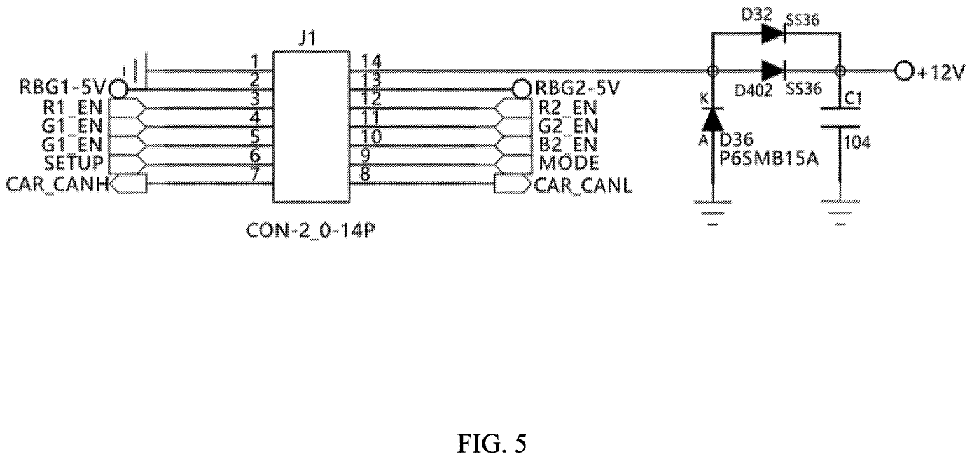

As shown in FIG. 5, the interface module 13 includes a connector J1 and its peripheral circuits. Where diodes D32 and D402 are used for power path control and preventing current backflow. A diode D36 is a core protective device, which clamps high voltage surges/static electricity and protects the backend circuit. A 14^{th} pin of the connector J1 is connected to the power supply voltage +12V of the vehicle power supply and filtered by the capacitor C1. The third working voltages RGB1_5V and RGB2_5V output by the two sets of third voltage reduction modules are respectively sent to a positive electrode of the LED indicator light through a 2^{nd} pin and a 13th pin of the connector J1. A 7^{th} pin and an 8^{th} pin of the connector J1 are connected to the high and low lines of the CAN bus, respectively, for transmitting CAN bus signals.

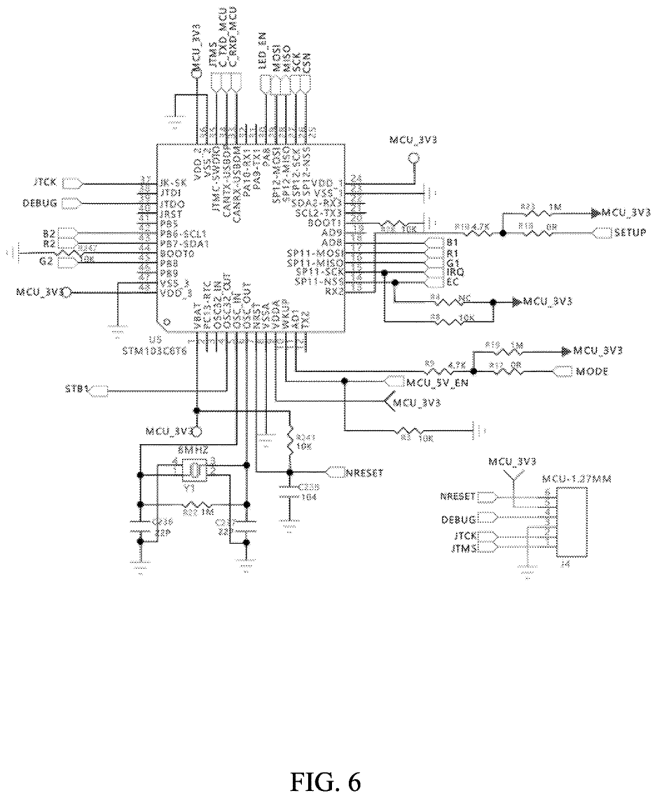

As shown in FIG. 6, the main control module 11 includes a main control chip U5 and its peripheral circuits. The specific connection relationships of each component can refer to the circuit schematic shown in FIG. 6, and will not be elaborated here.

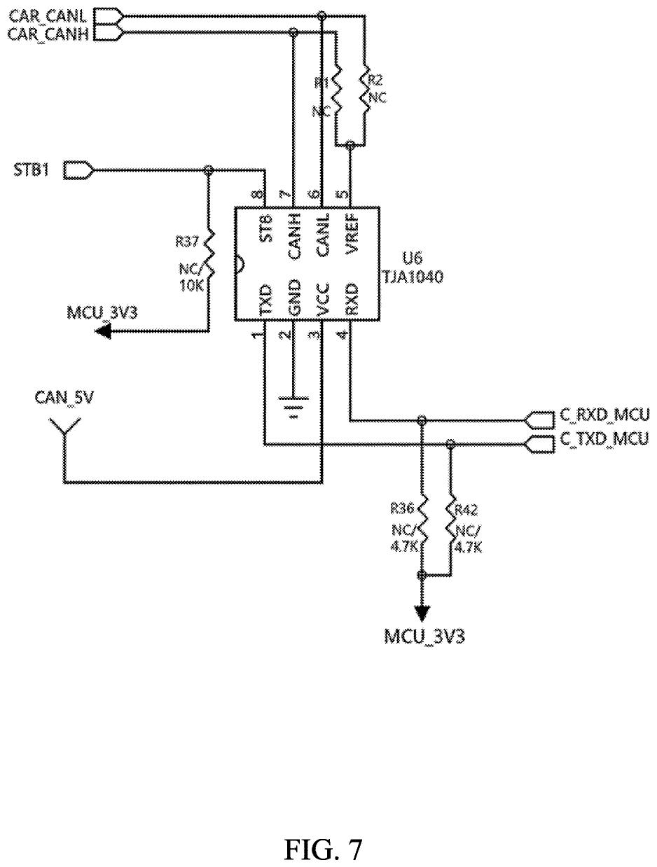

Referring to FIG. 7, the CAN decoding module 12 is a communication core of the vehicle's CAN bus, which realizes the decoding and level conversion of CAN bus signals, including a chip U6, a resistor R1, a resistor R2, a resistor R36, a resistor R37, and a resistor R42. The specific connection relationship of each component can refer to the circuit schematic shown in FIG. 7. Where each resistor plays a role in current limiting and pull-up voltage stabilizing, ensuring stable communication signals. A 6^{th} pin and a 7^{th} pin of the chip U6 are respectively connected to a 7^{th} pin and an 8^{th} pin of the connector J1 in the interface module 13, to be connected to the vehicle CAN bus through the interface module 13.

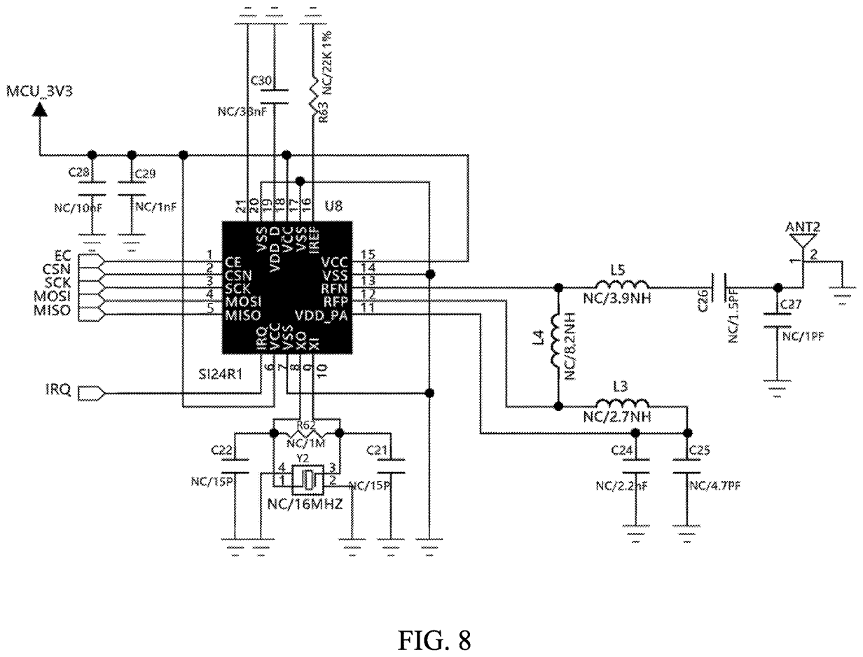

Referring to FIG. 8, the driving circuit 100 further includes a wireless communication module 16. The main control module 11 communicates bidirectionally with an external electrode device such as a mobile phone and a vehicle central control through the wireless communication module 16, supporting remote debugging of indicator light control parameters, real-time uploading of circuit working state, and receiving external remote-control commands. Where the circuit composition of wireless communication module 16 and the connection relationship of various components can refer to the circuit schematic shown in FIG. 8, which will not be elaborated here.

The LED light driving module 15 includes at least one driving unit, each of the driving unit is composed of a current limiting resistor, a voltage stabilizing resistor, and a MOS transistor to form a switch driving circuit. It has fast response speed, precise control, and no delay or lag. In an implementation mode, the driving unit includes a first resistor, a second resistor, and a Metal Oxide Semiconductor Field Effect Transistor, (MOS) transistor. The LED driving signal is transmitted to a gate electrode of the MOS transistor through the first resistor to achieve signal current limiting transmission. A source electrode of the MOS transistor is grounded, and a collector electrode is connected to a negative electrode of the LED indicator light through the interface module 13. A positive electrode of the LED indicator light is connected to the third working voltage RGB1_5V, forming a complete lamp bead power supply circuit. One end of the second resistor is connected to the gate electrode of the MOS transistor, and the other end thereof is grounded, serving to stabilize the gate voltage and prevent electrostatic breakdown.

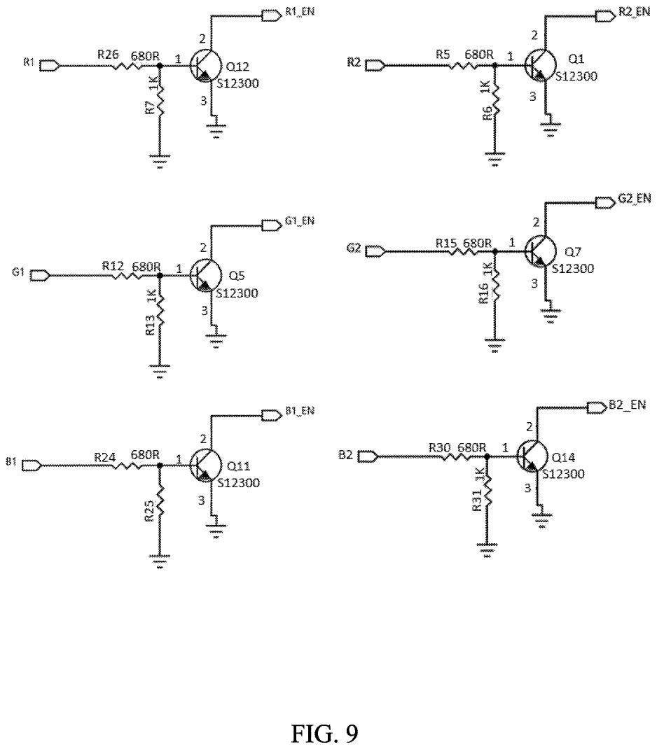

Referring to FIG. 9, in an implementation mode, the LED indicator light includes two sets of RGB three color light sources, with a total of six independent LED light beads. Six independent driving units are set up to control the six LED light beads respectively. The main control module 11 is configured to output six LED driving signals to the six driving units. The third working voltages RGB1_5V and RGB2_5V output by the two sets of the third voltage reduction module are configured to power the two sets of RGB three color light sources, respectively. Taking the driving unit of a first red LED bead as an example, the driving unit includes a first resistor R26, a second resistor R7, and the MOS transistor Q12. One end of the first resistor R26 is connected to an LED driving signal R1, and the other end is connected to a gate electrode of the MOS transistor Q12. One end of the second resistor R7 is connected to the gate electrode of the MOS transistor Q12, and the other end is grounded. A source electrode of the MOS transistor Q12 is grounded, and a collector electrode is connected to a negative electrode of the corresponding red LED bead through a 3^{rd} pin of the connector J1. A positive electrode of the red LED bead is connected to the third working voltage RGB1_5V through a 2^{nd} pin of the connector J1. When the main control module 11 sends a high-level driving signal, the MOS transistor Q12 conducts, and the red LED bead lights up when powered on. When a low-level driving signal is issued, the MOS transistor Q12 is turned off, and the red LED bead is turned off. The brightness and flashing frequency of the beads can also be controlled through PWM signal regulation.

It can be understood that in other embodiments of the present disclosure, the LED indicator light can also be composed of a single LED bead or multiple LED beads connected in series/parallel. At this time, the main control module 11 can control the working state of the six LED indicator lights through six LED driving signals.

In an implementation mode, LED indicator lights can be vehicle turn signals, brake lights, or other ambient lights, without limitation.

An embodiment of the present disclosure further provides a vehicle LED indicator device, which integrates the above-mentioned driving circuit 100 with the vehicle LED indicator light, and the overall layout conforms to the appearance and functional requirements of the vehicle.

The LED indicator lights include two outer side rearview mirror indicator lights, two inner side rearview mirror indicator lights, and a rear tail light. The main control module in the driving circuit 100 controls the working state of these five indicator lights by outputting five LED control signals. The two outer side rearview mirror indicator lights are respectively provided on outer sides of housing of a left rearview mirror and a right rearview mirror of the vehicle, the two inner side rearview mirror indicator lights are respectively provided on inner sides of housing of the left rearview mirror and the right rearview mirror of the vehicle; the rear tail light is provided outside of a rear of the vehicle. Where the inner side of the housing of the left and right rearview mirrors refers to the side where the left and right rearview mirrors are close to the vehicle body, while the outer side of the housing refers to the side where the left and right rearview mirrors are far away from the vehicle body.

In the embodiment of the present disclosure, the vehicle state signal includes a door opening command, a warning signal for an oncoming vehicle from one side, an intelligent driving mode activation command, a braking command, and a navigation mode selection command.

The driving circuit 100 is connected to the outer side rearview mirror indicator lights, the inner side rearview mirror indicator lights and the rear tail light, and is configured to drive an outer side rearview mirror indicator light on the same side as a door to light up when receiving an opening command of the door, drive the rearview mirror indicator light on the same side as an incoming vehicle when receiving a warning signal from the side, drive the rear tail light to light up in a first color when receiving an intelligent driving mode activation command, drive the rear tail light to light up in a second color when receiving a braking command, and drive the rear tail light to light up in a third color when receiving a navigation mode selection command.

In an implementation mode, the first color, second color, and third color are different colors; or, any two of the first color, the second color, and the third color can be the same color, where the same color corresponds to a high brightness constant state and a flashing state, respectively.

In an implementation mode, the indicator light device relies on the driving circuit 100 to achieve multi scene intelligent control, and the control logic is as follows.
1. Door opening prompt: when the CAN decoding module of the driving circuit 100 receives the door opening command transmitted by the vehicle CAN bus through the interface module, the main control module controls the outer side rearview mirror indicator light on the same side as the door opening to light up, thus playing a role in door opening safety prompt.
2. Incoming vehicle warning: when the CAN decoding module receives the incoming vehicle warning signal transmitted by a vehicle blind spot monitoring system through the interface module, the main control module drives the inner side rearview mirror indicator light on the same side as an incoming vehicle to light up, reminding the driver to pay attention to the incoming vehicle.
3. Intelligent driving mode indication: when the CAN decoding module receives the intelligent driving mode activation command through the interface module, the main control module controls the rear tail light to stay on in blue, indicating that the vehicle is in an intelligent driving mode.
4. Brake prompt: when the CAN decoding module receives a brake pedal trigger command through the interface module, the main control module controls the rear tail light to stay on in red, highlighting a need for the vehicle behind to slow down.
5. Navigation mode indication: when the CAN decoding module receives the navigation mode selection command through the interface module, the main control module controls the rear tail light to flash in red to distinguish different driving assistance modes.

This specification uses specific examples to explain the principles and implementation modes of the present disclosure. The above examples are only used to help understand the method and core idea of the present disclosure. Meanwhile, for those skilled in the art, there may be changes in the specific implementation and application scope based on the idea of the present disclosure. In summary, the content of this specification should not be understood as limiting the present disclosure.

What is claimed is:

1. A driving circuit for vehicle LED indicator light, comprising: a main control module, a CAN decoding module, an interface module, a power supply module, and an LED light driving module;
the interface module is connected to a vehicle power supply, and the power supply module is connected to the interface module, the main control module, the CAN decoding module, and the LED driving module to provide power supply;
the CAN decoding module is connected to a vehicle CAN bus through the interface module and is configured to receive a vehicle state signal transmitted on the vehicle CAN bus;
the main control module is connected to the CAN decoding module and is configured to generate a LED driving signal based on the vehicle state signal and transmit it to the LED light driving module;
the LED light driving module is connected to the LED indicator light through the interface module and is configured to control the LED indicator light to turn on according to the LED driving signal;
the power supply module comprises independent first voltage reduction module, second voltage reduction module, and third voltage reduction module;
the first voltage reduction module, second voltage reduction module, and third voltage reduction module are all connected to the interface module to obtain a power supply voltage of the vehicle power supply;
the first voltage reduction module is connected to the CAN decoding module to convert the power supply voltage into a first working voltage of the CAN decoding module;
the second voltage reduction module is connected to the main control module to convert the power supply voltage into a second working voltage of the main control module;
the third voltage reduction module is connected to the LED indicator light to convert the power supply voltage into a third working voltage of the LED indicator light.

2. The driving circuit for vehicle LED indicator light according to claim 1, wherein the first voltage reduction module comprises an inductor L1, a capacitor C5, a voltage regulator chip U4, a capacitor C8, a capacitor C9, and a capacitor C2;
one end of the inductor L1 is connected to the power supply voltage of the vehicle power supply, the other end of the inductor L1 and one end of the capacitor C5 are both connected to a 2^{nd} pin of the voltage regulator chip U4, the other end of the capacitor C5 and a 1^{st} pin of the voltage regulator chip U4 are grounded,
a 3^{rd} pin of the voltage regulator chip U4 outputs the first working voltage CAN_5V;
one end of the capacitor C8, one end of the capacitor C2, and one end of the capacitor C9 are all connected to the 3^{rd} pin of the voltage regulator chip U4, and the other ends are grounded.

3. The driving circuit for vehicle LED indicator light according to claim 1, wherein the second voltage reduction module comprises an inductor L1, a capacitor C105, a voltage regulator chip U12, a capacitor C3, a capacitor C106, a capacitor C107, a capacitor C108, a capacitor C109, a capacitor C110, and a capacitor C111;
one end of the inductor L11 is connected to the power supply voltage of the vehicle power supply, the other end of the inductor L11 and one end of the capacitor C105 are both connected to a 2^{nd} pin of the voltage regulator chip U12,
the other end of the capacitor C105 and a 1^{st} pin of the voltage regulator chip U12 are grounded,
a 3^{rd} pin of the voltage regulator chip U12 outputs the second working voltage MCU_3V3;
one end of the capacitor C3, one end of the capacitor C106, one end of the capacitor C107, one end of the capacitor C108, one end of the capacitor C109, one end of the capacitor C110, and one end of the capacitor C111 are all connected to the 3^{rd} pin of the voltage regulator chip U12, and the other ends are grounded.

4. The driving circuit for vehicle LED indicator light according to claim 1, wherein the third voltage reduction module comprises a power management chip U7, an inductor PL1, a diode D1, a resistor R41, a resistor R21, a resistor R27, a capacitor C10, a capacitor C11, a capacitor C12, a capacitor C13, a capacitor C14, a capacitor C15, a capacitor C16, a capacitor C18, a capacitor C19, a capacitor C20, and a capacitor C23;
after filtering through capacitors C11 and C12, the power supply of the vehicle power supply is connected to an 8^{th} pin of the chip U7; the resistor R41 is connected between a 7^{th} pin and the 8^{th} pin of the chip U7;
a 6^{th} pin and the 7^{th} pin of the chip U7 are grounded through capacitors C14 and C19, respectively;
the capacitor C10 is connected between a 1^{st} pin and a 2^{nd} pin of the chip U7;
the 2^{nd} pin of the chip U7 is connected to an output node through the inductor PL1 to output the third working voltage RGB1_5V through the output node;
a negative electrode of the diode D1 is connected to the 2^{nd} pin of the chip U7, and a positive electrode is grounded;
one end of the capacitor C16, one end of the capacitor C18, one end of the capacitor C20, and one end of the capacitor C23 are connected to the output node, and the other ends are grounded;
a resistor R21 and a capacitor C15 are connected in parallel between a 5^{th} pin of the chip U7 and the output node;
one end of the resistor R27 is connected to the 5^{th} pin of the chip U7, and the other end is grounded;
a 3^{rd} pin of the chip U7 is connected to an enable signal MCU_5V EN output by the main control module, and a 4^{th} pin of the chip U7 is grounded through the capacitor C13.

5. The driving circuit for vehicle LED indicator light according to claim 1, wherein the main control module comprises a main control chip U5,
a 24^{th} pin, a 36^{th} pin, and a 48^{th} pin of the main control chip U5 are all connected to the second working voltage;
the main control chip U5 outputs the enable signal MCU_5V EN to the third voltage reduction module through a 10^{th} pin;
the main control chip U5 outputs 6 control signals R1/G1/B1/R2/G2/B2 to the LED light driving module through a 17^{th} pin, a 16^{th} pin, a 18^{th} pin, a 43^{rd} pin, a 45^{th} pin, and a 42^{nd} pin;
the main control chip U5 is connected to the CAN decoding module through a 33^{rd} pin and a 34^{th} pin for data exchange.

6. The driving circuit for vehicle LED indicator light according to claim 5, wherein the CAN decoding module comprises a chip U6, a resistor R1, a resistor R2, a resistor R36, a resistor R37, and a resistor R42;
a 6^{th} pin and a 7^{th} pin of the chip U6 are respectively connected to the interface module so as to connect to a vehicle CAN bus through the interface module;
the resistor R1 is connected between a 7^{th} pin and a 5^{th} pin of the chip U6, and the resistor R2 is connected between a 6^{th} pin and the 5^{th} pin of the chip U6;
a 1^{st} pin and a 4^{th} pin of the chip U6 are respectively connected to a 34^{th} pin and a 33^{rd} pin of the main control chip U5;
the 1^{st} pin of the chip U6 is connected to the second working voltage through the resistor R42, the 4^{th} pin of the chip U6 is connected to the second working voltage through the resistor R1, an 8^{th} pin of the chip U6 is connected to the second working voltage through the resistor R37, and a 3^{rd} pin of the chip U6 is connected to the first working voltage.

7. The driving circuit for vehicle LED indicator light according to claim 1, further comprising a wireless communication module, wherein the main control module communicates bidirectionally with an external electrode device through the wireless communication module.

8. The driving circuit for vehicle LED indicator light according to claim 1, wherein LED light driving module comprises at least one driving unit, and the driving unit comprises a first resistor, a second resistor, and a MOS transistor;
the LED driving signal is transmitted to a gate electrode of the MOS transistor through the first resistor,
a source electrode of the MOS transistor is grounded;
a collector electrode is connected to a negative electrode of the LED indicator light through the interface module,
a positive electrode of the LED indicator light is connected to the third working voltage;
one end of the second resistor is connected to the gate electrode of the MOS transistor, and the other end is grounded.

9. A vehicle LED indicator light device, comprising an LED indicator light and the driving circuit according to claim 1;
the LED indicator light comprises two outer side rearview mirror indicator lights, two inner side rearview mirror indicator lights, and a rear tail light;
the two outer side rearview mirror indicator lights are respectively provided on outer sides of housing of a left rearview mirror and a right rearview mirror of the vehicle,
the two inner side rearview mirror indicator lights are respectively provided on inner sides of housing of the left rearview mirror and the right rearview mirror of the vehicle;
the rear tail light is provided outside of a rear of the vehicle;
the driving circuit is connected to the outer side rearview mirror indicator lights, the inner side rearview mirror indicator lights, and the rear tail light, and is configured to drive an outer side rearview mirror indicator light on the same side as a door to light up when receiving an opening command of the door, drive the rearview mirror indicator light on the same side as an incoming vehicle when receiving a warning signal from the side, drive the rear tail light to light up in a first color when receiving an intelligent driving mode activation command, drive the rear tail light to light up in a second color when receiving a braking command, and drive the rear tail light to light up in a third color when receiving a navigation mode selection command.

10. The vehicle LED indicator light device according to claim 9, wherein the first color, second color, and third color are different colors; or
any two of the first color, second color, and third color are the same color, where the same color corresponds to a high brightness constant state and a flashing state, respectively.
